(19) United States
(12) Patent Application Publication
(10) Pub. No.: US 2009/0308291 A1
(43) Pub. Date: Dec. 17, 2009

(54) SAFES WITH ROTATING INNER SUPPORTS

(75) Inventor: Bruce Pendleton, Loganville, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Pendleton Safe Company

(21) Appl. No.: 12/492,425

(22) Filed: Jun. 26, 2009

Related U.S. Application Data
(63) Continuation-in-part of application No. 12/054,091, filed on Mar. 24, 2008.

(51) Int. Cl. E05G 1/02

(52) U.S. Cl. 109/48

(57) ABSTRACT

Safes according to various embodiments of the invention include a housing defining a storage chamber. In various embodiments, the housing includes a first, partially cylindrical enclosure, and a second portion that extends outwardly from the first portion. In particular embodiments, the second portion is in communication with the first portion of the chamber and an access opening. Further embodiments include a rotatable item support assembly defining a shelf portion. In various embodiments, the item support is adapted so that, when rotated, moves between a first position, in which the shelf portion is disposed within the first portion of the storage chamber, and a second position, in which the shelf portion is disposed within the second portion of the storage chamber. Various embodiments include a door preventing access to the chamber through the access opening.

### CROSS-REFERENCE TO RELATED APPLICATIONS

This application is a continuation-in-part patent application of U.S. patent application Ser. No. 12/054,091, filed Mar. 24, 2008, the contents of which are incorporated herein by reference in their entirety.

### BACKGROUND OF THE INVENTION

Current gun safes are typically in the form of a metal, upright, rectangular box that includes a rectangular door at the front of the box. One disadvantage of such gun safes is that they are not well suited for the storage and management of large numbers of firearms. For example, a user storing 40 rifles in a particular rectangular gun safe may have to remove 20 or more of the rifles in order to access a particular rifle at the back of the safe. This can be inconvenient and time consuming, especially because most gun safes do not include a light for viewing guns stored in the rear interior portion of the safe.

Also, to conserve space, most current gun safes are stored in the corner of a room. Due to the rectangular box structure of these gun safes and the structure and orientation of the gun safe's doors, this often results in the door forming an angle of less than 90 degrees with the gun safe's access opening when the door is opened. This can limit access to the gun safe's interior.

### SUMMARY OF VARIOUS EMBODIMENTS OF THE INVENTION

A safe according to various embodiments of the present invention includes a housing defining a storage chamber that includes: (1) a first, partially cylindrical, housing portion that defines a first portion of the storage chamber; and (2) a second housing portion that extends outwardly (e.g., radially outwardly) from the first housing portion. In various embodiments, the second housing portion defines a second portion of the storage chamber that is in communication with the first portion of the storage chamber. The second housing portion also defines an access opening. In particular embodiments, the safe includes an access door for selectively preventing access to the safe's storage chamber through the access opening.

In various embodiments, the second housing portion is substantially in the shape of a cuboid. In particular embodiments, the second housing portion is substantially in the shape of a rectangular prism. Also, in particular embodiments, the second housing portion has a substantially trapezoidal shape as viewed from the bottom (or top) of the safe.

In certain embodiments, the safe includes a rotatable item support assembly defining a shelf portion. For example, in one embodiment, the safe is a gun safe and the rotatable item support assembly is adapted to support rifles in at least a substantially upright position (or other suitable orientation) adjacent a perimeter of a portion of the item support assembly. In various embodiments, the rotatable item support is adapted so that, as the rotatable item support is rotated, the shelf portion moves between (A) a first position in which the shelf portion is disposed within the first portion of the storage chamber; and (B) a second position in which the shelf portion is disposed within the second portion of the storage chamber.

In various embodiments, the rotatable item support assembly includes a substantially circular support that is mounted to rotate about a rotational axis that extends through the center of the circular support, and the shelf portion is a portion of the substantially circular support that is disposed adjacent an outer perimeter of the circular support.

In certain embodiments, less than about 98% of the circular support is disposed within the first portion of the storage chamber, and more than about 2% of the support is disposed within the second portion of the storage chamber. In further embodiments, the diameter of the substantially circular support is at least about 96% of the diameter of the first housing portion.

In various embodiments, the rotatable item support assembly includes a second shelf portion. In certain embodiments, the rotatable item support is adapted so that, as the rotatable item support is rotated, the second shelf portion moves between (A) a first position in which the second shelf portion is disposed within the first portion of the storage chamber; and (B) a second position in which the second shelf portion is disposed within the second portion of the storage chamber. Furthermore, in particular embodiments, the rotatable item support assembly includes a second substantially circular support that is mounted to rotate about the rotational axis and the rotational axis extends through a center of the second circular support.

A safe according to various embodiments comprises a housing defining a storage chamber, the housing comprising: (1) a first, partially cylindrical, (e.g., substantially vertical) housing portion that defines a first portion of the storage chamber; (2) a second housing portion that extends outwardly from the first housing portion. In particular embodiments, the second housing portion defines a second portion of the storage chamber that is in communication with the first portion of the storage chamber, and an access opening. In particular embodiments, the safe further includes an access door that is disposed adjacent the access opening and that is adapted for selectively preventing access to the storage chamber through the access opening.

In particular embodiments, the safe further comprises a substantially horizontal, rotatable (e.g., substantially circular) support shelf disposed in the storage chamber, the support shelf having a maximum horizontal width that is less than about 5% shorter than a diameter of the partially cylindrical housing portion. In particular embodiments, a first portion of the support shelf is disposed within the first housing portion, and a second portion of the support shelf is disposed within the second housing portion.

In various embodiments, the rotatable support shelf is substantially circular, and the support shelf is adapted so that, as the support shelf is rotated, a portion of the support shelf's perimeter moves from (A) a first position in which the shelf perimeter portion is disposed within the first portion of the storage chamber to (B) a second position in which the shelf perimeter portion is disposed within the second portion of the storage chamber. In particular embodiments, the diameter of the support shelf is less than about 5% shorter than a diameter of the first housing portion.

In various embodiments: (A) the support shelf is a first support shelf comprising a first shelf portion that is adjacent a perimeter of the first support shelf, and (B) the support shelf is a second support shelf comprising a second shelf portion that is adjacent a perimeter of the second support shelf. In such embodiments, the safe may be adapted so that, as the first support shelf is rotated, the first shelf portion moves from (A) a first position in which the first shelf portion is disposed within the first portion of the storage chamber; to (B) a second position in which the first shelf portion is disposed within the second portion of the storage chamber. In addition, the safe may be adapted so that, as the second support shelf is rotated, the second shelf portion moves from (A) a first position in which the second shelf portion is disposed within the first portion of the storage chamber to (B) a second position in which the second shelf portion is disposed within the second portion of the storage chamber.

### BRIEF DESCRIPTION OF THE DRAWINGS

Having thus described various embodiments of the invention in general terms, reference will now be made to the accompanying drawings, which are not necessarily drawn to scale, and wherein:

FIG. 1 is a perspective view of a gun safe according to a particular embodiment of the invention. In this figure, the gun safe's access door is shown closed.

FIG. 2 is a perspective front view of the gun safe of FIG. 1. In this figure, the gun safe's access door is shown open.

FIGS. 3 and 4 are perspective, close-up views of portions of the gun support assembly shown in FIG. 1.

FIG. 4 is a perspective view of a gun safe according to a particular embodiment of the invention.

FIG. 5 is a bottom view of the gun safe shown in FIG. 1.

FIG. 6A is a top, plan view of a gun barrel support assembly according to an alternative embodiment of the invention.

FIG. 6B is a side view of the gun barrel support assembly of FIG. 6A showing an exemplary barrel support member.

FIG. 7 is a bottom view of a gun safe according to an alternative embodiment of the invention.

### DETAILED DESCRIPTION OF VARIOUS EMBODIMENTS OF THE INVENTION

Various embodiments of the present invention will now be described more fully hereinafter with reference to the accompanying drawings, in which various embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Structure of Exemplary Gun Safe

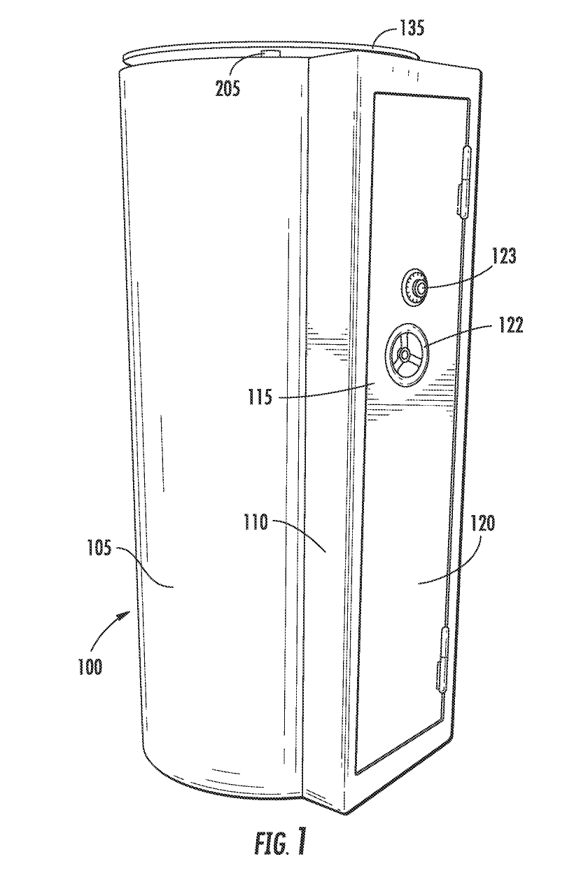

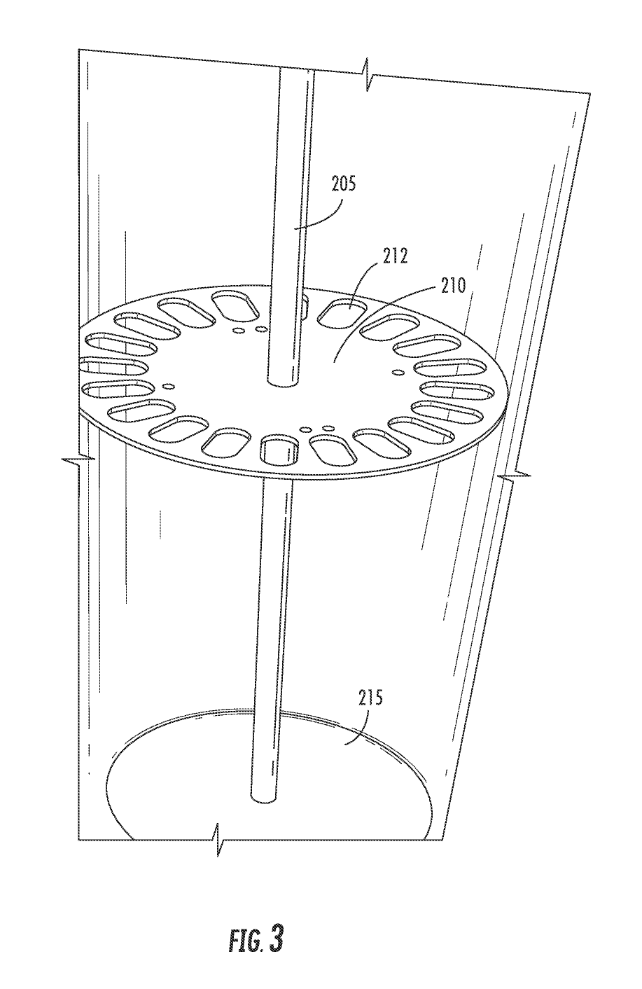

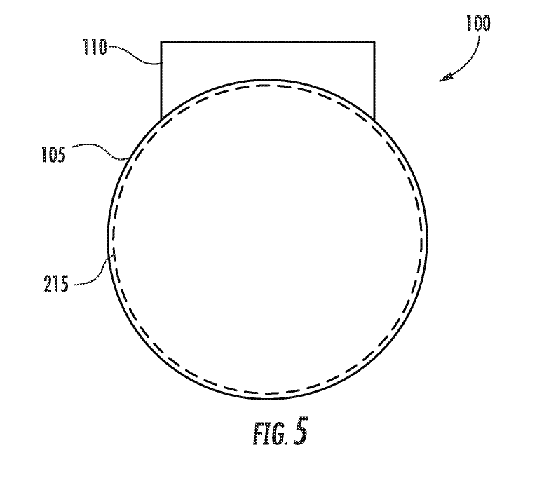

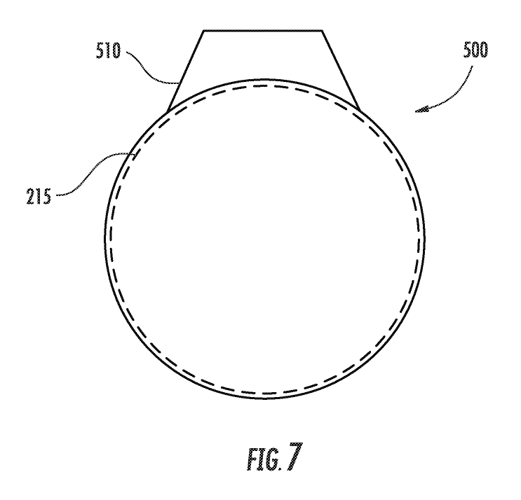

As shown in FIGS. 1-5, a gun safe 100 according to a particular embodiment of the invention comprises a substantially cylindrical outer housing 105 that defines a thin, elongate, upright access passage 110 that extends radially outwardly from an outer side portion of the substantially cylindrical outer housing 105. A substantially rectangular access door 120 is mounted at the outer end of this access passage 110. The access passage 110 has a substantially rectangular shape as viewed from the bottom of the safe 100. In particular embodiments, the shape of the access passage 110 may be a cuboid and/or a rectangular prism. According to other various embodiments, such as the embodiment shown in FIG. 7, the access passage 510 has a substantially trapezoidal shape as viewed from the bottom of the safe 500.

The outer housing 105 defines an interior portion that is dimensioned for storing a plurality of rifles 300, and the access door 120 is adapted to selectively restrict access to this interior portion. In particular embodiments, the access door includes a lock 123 (e.g., a combination lock) that is adapted for selectively maintaining the access door 120 in a closed and locked orientation in which the access door 120 prevents access to the outer housing's interior portion.

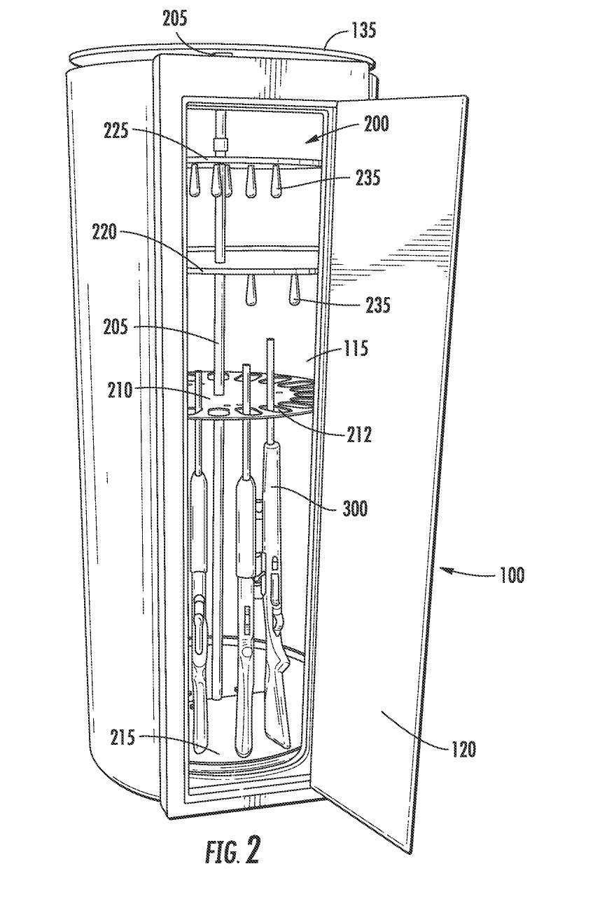

As shown in FIGS. 2-4, in various embodiments, the gun safe 100 includes a rotatable interior gun support assembly 200 that is adapted to support rifles 300 in an upright position adjacent a perimeter of a portion of the gun support assembly 200. For example, in particular embodiments, the gun support assembly 200 includes a substantially circular, substantially horizontal, rotatable gun barrel support member 210 that is adapted to support rifles 300 in at least a substantially upright position adjacent the gun barrel support member's outside perimeter, as shown in FIG. 2.

In particular embodiments, the gun support assembly 200 includes a central, vertical shaft 205 that extends substantially through a center portion of the gun support assembly 200. This shaft 205 is preferably rotatably mounted on bearings (not shown) at the top and bottom of the shaft 205. In particular embodiments, these bearings are attached, respectively, approximately adjacent the center of the ceiling and floor of the gun safe 100.

In various embodiments, the barrel support member 210 is mounted adjacent (e.g., on) the central shaft 205 so that the central shaft 205 extends through substantially the center of the barrel support member 210. Accordingly, in particular embodiments, the barrel support member 210 may rotate in a substantially symmetrical manner about the central axis of the central shaft 205. In various embodiments, the barrel support member 210 includes a plurality of cutouts 212 that are spaced (preferably at regular intervals) about the circumference of the barrel support member 210. These cutouts 212 are preferably dimensioned to provide lateral support for the barrel portions of the rifles 300 stored in the gun safe 100. In the embodiment shown in FIG. 2, these cutouts 212 are substantially oval in shape. In an alternative embodiment, the cutouts 212 may be in the form of a half-circle that is formed by the perimeter of the barrel support member 210. In various embodiments, the half-circular cutouts are adapted to substantially conform to the shape of a standard rifle barrel.

In particular embodiments, the gun support assembly 200 further includes a lower, substantially circular (e.g., substantially planar, substantially horizontal) support shelf 215 for supporting the butts of rifles 300 stored in the gun safe 100. Also, in various embodiments, the gun support assembly 200 further includes one or more upper, substantially circular (e.g., substantially planar, substantially horizontal) support shelves 220, 225, 135 that are adapted for holding items such as ammunition and/or pistols.

In a particular embodiment, at least one of these support shelves is disposed outside of the interior of the gun safe's outer housing 105. For example, in the embodiment shown in FIG. 2, the gun support assembly 200 includes an external upper shelf 135 that is disposed above and adjacent a top surface of the gun safe's outer housing 105. In this embodiment, the upper shelf 135 is spaced apart from the top surface of the outer housing 105 so that the upper shelf 135 may rotate freely without engaging the top surface of the outer housing 105. In other embodiments, the external upper shelf 135 may engage the top surface of the outer housing 105.

In various embodiments, the lower support shelf 215 and one or more upper support shelves 220, 225, 135 are mounted adjacent (e.g., on) the central shaft 205 so that the central shaft 205 extends through the respective center portions of the lower support shelf 215 and the upper support shelves 220, 225, 135. Accordingly, in particular embodiments, the lower support shelf 215 and one or more upper support shelves 220, 225, 135 may rotate in a substantially symmetrical manner about the central axis of the central shaft 205. In particular embodiments, one or more of (and, in certain embodiments, all of) the lower and upper support shelves 215, 220, 225, 135 and the barrel support member 210 are mounted to the central shaft 205 and are mounted to rotate at least substantially in tandem about the central axis of the central shaft 205. In particular embodiments, the central shaft 205 is mounted to drive one or more (and, in certain embodiments, all) of: (A) the lower support shelf 215; (B) the upper support shelves 220, 225, 135; and (C) the barrel support member 210.

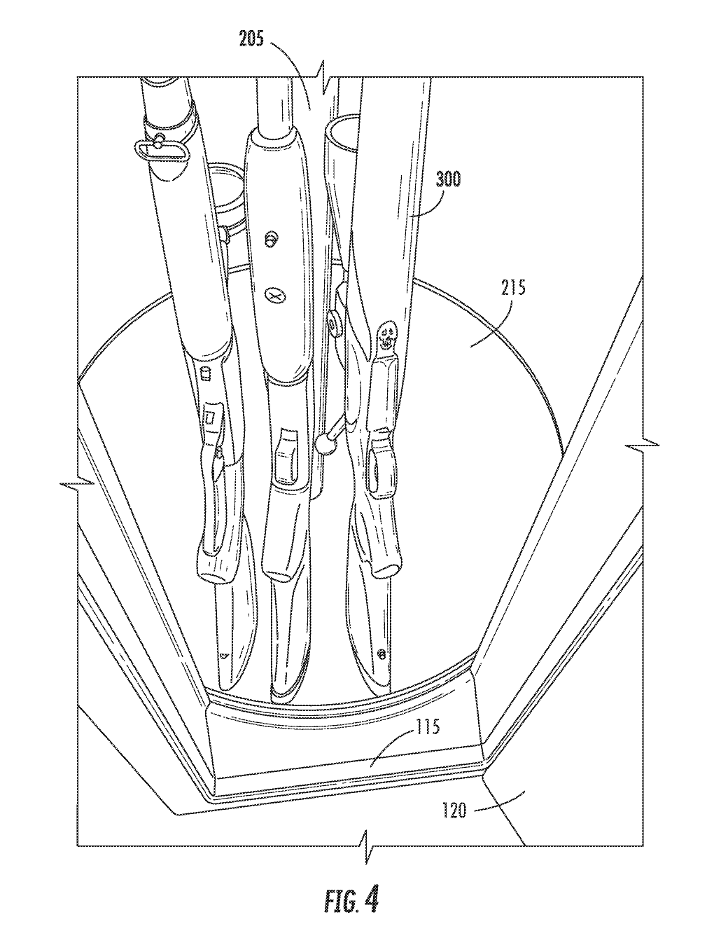

As shown in FIG. 4, in particular embodiments, when the gun support assembly 200 is rotated, the lower support shelf 215 moves between: (1) a first position in which a first portion of the lower support shelf 215 is disposed within the interior of the access passage 110; and (2) a second position in which the first portion of the lower support shelf 215 is disposed within the interior of the outer housing 105. In particular embodiments, the distance across the lower support shelf 215 (e.g., the diameter of the lower support shelf 215) is about the same as the distance across the interior of the outer housing 105 (e.g., the diameter of the outer housing's interior). For instance, in one embodiment, the diameter of the lower support shelf 215 is at least 96% of the diameter of the interior of the safe's outer housing 105.

In addition, according to one embodiment, less than about 98% of the lower support shelf 215 is disposed within the interior of the outer housing 105 and more than about 2% of the lower support shelf 215 is disposed within in the interior of the access passage 110.

It should be understood that, while the barrel support member 210, lower support shelf 215, and upper support shelves 220, 225, 135 are described herein as being substantially circular in shape, these shelves may be other shapes in alternative embodiments of the invention. For example, one or more of the shelves may be in the shape of a half circle, a square, a rectangle, or an oval.

### Operation of Exemplary Gun Safe

In particular embodiments, in order to select a particular rifle from the gun safe 100, a user first unlocks and opens the gun safe's access door 120. The user then rotates the gun support assembly 200 about the central shaft 205 (either manually or via suitable controls for a motor attached to drive the central shaft 205) until the desired rifle 300 is adjacent the rectangular access passage 110. The user then removes the rifle 300 from the gun safe 100 through the rectangular access passage 110.

In particular embodiments of the invention, the gun safe 100 is adapted to allow the user to rotate the gun support assembly 200 in multiple different ways. For example, in the embodiment shown in FIG. 2, the user may rotate the gun support assembly 200 by manually exerting a rotating force (e.g., with their hand) adjacent a perimeter of any of the gun support assembly's upper shelves 220, 225, 135. Alternatively, the user may rotate the gun support assembly 200 by exerting a pushing or pulling force on one or more handles 235 that extend downwardly (or in any other suitable direction) from one or more of the gun support assembly's upper shelves 220, 225, 135. In other embodiments, the gun safe 100 may include a motor for rotating the gun support assembly 200 about its central shaft 205. In particular embodiments, the gun safe 100 may be configured to use the motor to selectively rotate the gun support assembly in two different directions (e.g., the motor may selectively rotate the gun support assembly 200 clockwise or counterclockwise about the central shaft 205, as specified by a user).

### Alternative Embodiments of the Gun Safe

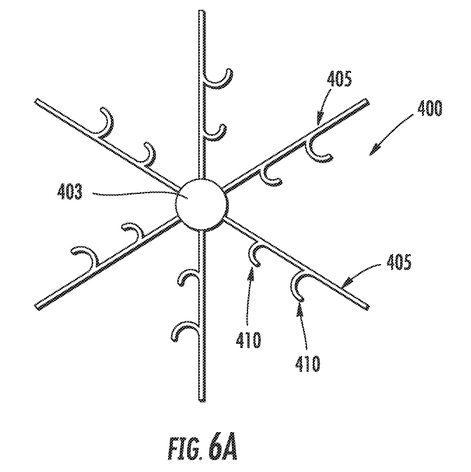

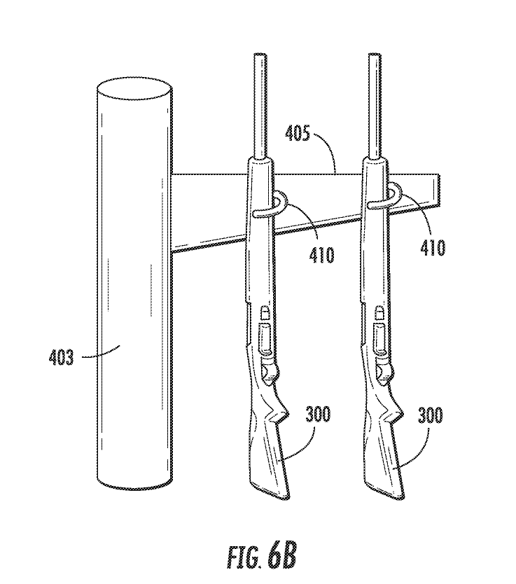

In a first alternative embodiment of the gun safe, rather than including a gun barrel support member that includes exterior cutouts for supporting the barrel portions of rifles, the gun safe may include an alternative gun barrel support member 400 having a series of radial support extensions 405 that extend radially outwardly from the central shaft 403 as shown in FIGS. 6A and 6B of the provided figures. In particular embodiments, each of these radial support extensions 405 may include multiple rifle barrel support hooks 410. This allows rifles to be stored in a double-nested arrangement (e.g., two rifles per radial support extension 405), which serves to increase the gun safe's storage capacity.

In a second alternative embodiment, rather than a barrel support member that includes exterior cutouts for supporting the barrel portions of rifles, the gun safe may include a series of pistol support assemblies, each of which is configured for allowing a user to hang a pistol in a particular position within the gun safe. This may allow a large number of pistols to be stored within, and easily accessed from, the gun safe.

In particular embodiments, the gun safe's gun barrel support member and various support shelves may be manually rotated about the gun safe's central shaft. In other embodiments, the gun safe may include a motor that is adapted to selectively rotate the gun barrel support member and substantially circular support shelves about the gun safe's central shaft. In such embodiments, a user may selectively activate the motor by using, for example, a switch adjacent the gun safe's access door. In particular embodiments, the gun safe 100 may be configured to use the motor to selectively rotate the gun barrel support member and substantially circular support shelves about the gun safe's central shaft in two different directions (e.g., the motor may selectively rotate the gun support assembly 200 clockwise or counterclockwise about the central shaft 205, as specified by a user).

### CONCLUSION

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. Also, it should be understood that, while various embodiments of the invention are described herein as being adapted for the storage of guns, other embodiments may be used for the storage of other items. Therefore, it is to be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

1. A safe comprising:
(A) a housing defining a storage chamber, said housing comprising:
a first, partially cylindrical, housing portion that defines a first portion of said storage chamber;
a second housing portion that extends outwardly from said first housing portion, said second housing portion defining:
a second portion of said storage chamber that is in communication with said first portion of said storage chamber, and
an access opening;
(B) a rotatable item support assembly defining a shelf portion, said rotatable item support being adapted so that, as said rotatable item support is rotated, said shelf portion
moves between: (1) a first position in which said shelf portion is disposed within said first portion of said storage chamber; and (2) a second position in which said shelf portion is disposed within said second portion of said storage chamber; and
(C) a door, disposed adjacent said access opening, that is adapted for selectively preventing access to said storage chamber through said access opening.

2. The safe of claim 1, wherein said second housing portion is substantially in a shape of a cuboid.

3. The safe of claim 2, wherein said second housing portion is substantially in a shape of a rectangular prism.

4. The safe of claim 3, wherein said second housing portion extends radially outwardly from said first housing portion.

5. The safe of claim 1, wherein:
said safe is a gun safe; and
said rotatable item support assembly is adapted to support at least one gun.

6. The safe of claim 1, wherein said rotatable item support assembly comprises a substantially circular support that is mounted to rotate about a rotational axis that extends through a center of said circular support.

7. The safe of claim 6, wherein:
said shelf portion is a portion of said substantially circular support that is disposed adjacent an outer perimeter of said shelf portion.

8. The safe of claim 7, wherein:
said substantially circular support is a first substantially circular support;
said shelf portion is a first shelf portion;
said rotatable item support assembly comprises a second shelf portion;
said rotatable item support is adapted so that, as said rotatable item support is rotated, said second shelf portion moves between: (A) a first position in which said second shelf portion is disposed within said first portion of said storage chamber; and (B) a second position in which said second shelf portion is disposed within said second portion of said storage chamber;
said rotatable item support assembly comprises a second substantially circular support that is mounted to rotate about said rotational axis; and
said rotational axis extends through a center of said second circular support.

9. The safe of claim 8, wherein said second housing portion is substantially in a shape of a cuboid.

10. The safe of claim 1, wherein:
said rotatable item support assembly comprises a substantially circular support that is mounted to rotate about a rotational axis that extends through a center of said circular support;
less than about 98% of said substantially circular support is disposed within said first portion of said storage chamber; and
more than about 2% of said substantially circular support is disposed within said second portion of said storage chamber.

11. The safe of claim 1, wherein:
said rotatable item support assembly comprises a substantially circular support that is mounted to rotate about a rotational axis that extends through a center of said circular support;
a diameter of said substantially circular support is less than about 5% shorter than a diameter of said first housing portion.

12. A safe comprising:
a housing defining a storage chamber, said housing comprising:
a first, partially cylindrical, housing portion that defines a first portion of said storage chamber;
a second housing portion that extends outwardly from said first housing portion, said second housing portion defining:
a second portion of said storage chamber that is in communication with said first portion of said storage chamber, and
an access opening;
a substantially horizontal, rotatable support shelf disposed in said storage chamber, said support shelf having a maximum horizontal width that is less than about 5% shorter than a diameter of said partially cylindrical housing portion; and
a door, disposed adjacent said access opening, that is adapted for selectively preventing access to said storage chamber through said access opening, wherein:
a first portion of said support shelf is disposed within said first housing portion; and
a second portion of said support shelf is disposed within said second housing portion.

13. The safe of claim 12, wherein:
said safe is a gun safe; and
said rotatable support shelf is adapted to support at least one gun.

14. The safe of claim 12, wherein said rotatable support shelf is adapted so that, as said rotatable support shelf is rotated, a portion of said support shelf's perimeter moves from (A) a first position in which said shelf perimeter portion is disposed within said first portion of said storage chamber; to (B) a second position in which said shelf perimeter portion is disposed within said second portion of said storage chamber.

15. The safe of claim 14, wherein said partially cylindrical housing is at least substantially vertical.

16. The safe of claim 12, wherein said second housing portion is substantially in a shape of a cuboid.

17. The safe of claim 12, wherein said second housing portion is substantially in a shape of a rectangular prism.

18. The safe of claim 17, wherein said second housing portion extends radially outwardly from said first housing portion.

19. The safe of claim 12, wherein said support shelf is substantially circular and is mounted to rotate about a rotational axis that extends through a center of said support shelf.

20. The safe of claim 19, wherein:
a diameter of said support shelf is less than about 5% shorter than a diameter of said first housing portion.

21. The safe of claim 19, wherein:
said support shelf is a first support shelf comprising a first shelf portion that is adjacent a perimeter of said first support shelf,
said support shelf is a second support shelf comprising a second shelf portion that is adjacent a perimeter of said second support shelf,
said safe is adapted so that:
as said first support shelf is rotated, said first shelf portion moves from (A) a first position in which said first shelf portion is disposed within said first portion of said storage chamber; to (B) a second position in which said first shelf portion is disposed within said second portion of said storage chamber; and
as said second support shelf is rotated, said second shelf portion moves from (A) a first position in which said second shelf portion is disposed within said first portion of said storage chamber; to (B) a second position in which said second shelf portion is disposed within said second portion of said storage chamber.
